(19) United States
(12) Patent Application Publication
(10) Pub. No.: US 2022/0251858 A1
(43) Pub. Date: Aug. 11, 2022

(54) ANCHOR FOR A SELF-CLIMBING STRUCTURE

(71) Applicant: HWS CONCRETE TOWERS S.L., SAN SEBASTIAN (ES)

(72) Inventors: Jesus MONTANER FRAGUET, SAN SEBASTIAN (ES); Mariano PEREZ ABADIA, SAN SEBASTIAN (ES); Jose Manuel SORAZU ECHAVE, SAN SEBASTIAN (ES); Amaia MARTINEZ MARTINEZ, SAN SEBASTIAN (ES); Sergio SAIZ GARCIA, SAN SEBASTIAN (ES); Ricardo DIEGO GARAMENDI, SAN SEBASTIAN (ES)

(73) Assignee: HWS CONCRETE TOWERS S.L., SAN SEBASTIAN (ES)

(21) Appl. No.: 17/628,878

(22) PCT Filed: Jul. 16, 2020
(86) PCT No.: PCT/ES2020/070463

§ 371 Date: Jan. 20, 2022

(30) Foreign Application Priority Data
Jul. 30, 2019 (ES) P201930707

(51) Int. Cl. E04G 5/04; E04G 3/28; B66C 23/24

(52) U.S. Cl. CPC E04G 5/046; E04G 3/28; E04G 11/28; E04G 2003/286; B66C 23/24

(57) ABSTRACT

An anchor for self-climbing structure of the type used on vertical or near-vertical concrete surfaces that uses metal inserts in the precast concrete tower and interlocking spikes in the self-climbing structure that are provided with rotary and rocking movement is disclosed. The anchor affords the main advantage of minimising tensile and shear loads on the concrete of the tower with maximum contact and optimum load distribution, while also achieving self-correction of possible coupling positioning and alignment errors. All of this results in improved delivery and distribution of the loads from the climbing device to the concrete wall and general structure that allows larger sized loads to be lifted and withstood than existing devices.

This description relates, as its title indicates, to an anchor for the type of self-climbing structure used on vertical and near-vertical concrete surfaces, for example in the assembly and maintenance of totally or partially precast concrete towers, the self-climbing structure being able to be used for the support of cranes, platforms, and other auxiliary elements. The anchor uses metal inserts in the precast concrete tower and interlocking spikes in the self-climbing structure that are provided with rotary and rocking movement.

### FIELD OF THE INVENTION

The invention refers to the field of self-climbing structures used by vertical and near-vertical concrete surfaces.

### CURRENT STATE OF THE ART

A great number of self-climbing devices and structures are currently known and used in the field of construction, among which are patents EP2725166 “Method for creating concreting sections with the aid of a rail-guided self-climbing formwork system”, EP1899549 “Climbing cylinder on a self-climbing shuttering”, WO2009117986 “Track-guided self-climbing shuttering system with climbing rail extension pieces”, EP2365159 “Self-climbing perimeter protection system for construction works in buildings” and WO2008061922 “Self-climbing system in the field of the construction industry with a climbing or guide shoe”. However all of them have a common problem in that they require tracks, guides or rails attached to the surface to be worked on, or, in any case, elements designed and made expressly for each case and which cannot be reused, with the consequent increased cost of the climbing system, which complicates and increases the cost of its assembly and subsequent dismantling, as well as only being applicable on near-flat surfaces, at least in one direction, which means that in many cases they are not applicable, for example, in multi-section precast concrete towers with a freely varying cross section.

Equipment is also known such as that described in patent ES2085196 “System of self-climbing formwork and continuous support of concrete”, which uses anchoring cones to secure to the wall, but which is not a structure that climbs autonomously, but rather is formwork for dams which is dismantled from the bottom and raised towards the top in a relatively manual way.

Likewise there are some devices such as that described in patent ES2695626 “Self-climbing device on vertical and near-vertical concrete surfaces and operating method” which have means of anchoring to the work wall, which comprise a protuberance from the anchor chassis, emerging on the face adjacent to the work wall, provided with one or several operable locking elements arranged laterally on the said protuberance, the shape and size of the said protuberances coinciding with anchor housings in the work wall, arranged in a vertical line, and these anchor housings having locking housings of a shape, size and position that coincide with the locking elements. The shape of the protuberance from the anchor chassis and of the anchor housings in the work wall is a truncated pyramid or truncated cone. This type of anchor that is used presents the problem of requiring great precision, both in positioning the anchor elements in the tower modules, and aligning the lateral locking elements for their actuation, which in the event of any slight deviations in measurements, any dirt or dilatations in materials, or misalignments, may lead to coupling failures which prevent the correct operation of the self-supporting structure, and which may be impossible to resolve or offset.

Furthermore, the anchoring of the crane in the concrete tower is delicate as concrete does not withstand tensile or shear loads well, so that, in order not to weaken the tower, the effect of the connection of the crane on the segment must be minimal, which is not the case in these embodiments.

### DESCRIPTION OF THE INVENTION

To resolve the problem that currently exists with fixing self-supporting structures on concrete surfaces, minimising traction and shear loads and allowing self-correction of possible coupling positioning and alignment errors, the anchor for self-climbing structure which is the object of this invention has been envisaged, which comprises
on the vertical or near-vertical concrete surface, for example a tower or concrete surface, either precast or built in situ, metal inserts which form openings in the wall at different heights on the vertical or near-vertical concrete surface,
on the self-climbing structure, interlocking spikes, with an appropriate distribution and dimensions for insertion and coupling in the metal inserts, located in each of various frames, all of which may be movable or some of them fixed, of the said self-climbing structure, the said interlocking spikes being provided with means of horizontal displacement and means of approach or distancing in relation to the tower or concrete surface precast or built in situ.

The metal inserts and interlocking spikes can be distributed either one by one, or in pairs, or in groups of three or more.

The openings in the wall can be through-hole openings, and in this case the metal inserts are shaped as a hollow body finished at both ends by two peripheral end surfaces of a larger size, defining a common opening. Also, they may not be through-hole openings but rather adopt the shape of a hollow or niche, in which case the metal inserts are closed at one of the ends.

The interlocking spikes comprise an inner shaft with a spherical end, a main body enveloping the spherical end of the inner shaft and provided with free rotation movement in relation to it, the lower part of the main body being semi-circular, and end plates attached to the front and rear ends of the main body, and which protrude from the said main body at the bottom. In a coupling position, the interlocking spikes are inserted into various metal inserts in such a way that the lower part of each main body of the interlocking spike is in contact with the inner part of the hollow body of its corresponding metal insert, transmitting the weight of the self-climbing structure to the tower and maintaining its position due to that weight, while the end plates fit against the peripheral end surfaces of the metal inserts, blocking any horizontal displacement of the interlocking spikes, and thus preventing them from coming loose. The interlocking spikes are fixed, if in pairs, on both ends of a central arm, provided with free rotation movement, by means of a shaft, with respect to the main support of the assembly.

Optionally, the interlocking spikes are provided with multiple chamfers, both on the main body and on the end plates.

### Advantages of the Invention

This anchor for self-climbing structure that is presented provides multiple advantages over the equipment currently available, the most important being that as it uses appropriately-sized, round metal inserts, the tensile and shear loads on the concrete of the vertical and near-vertical concrete surface are minimised.

Another notable advantage is that in order to ensure the even, centred distribution of loads, a spherical support has been used, which has the same radius at the point of support and on the support, guaranteeing maximum contact and optimal load distribution.

Furthermore, it is to be noted that to absorb any errors in the manufacture of the metal inserts in the tower and the interlocking spikes in the self-supporting structure, the latter have been provided with the necessary articulations to ensure total contact between surfaces of the same radius, which allows optimal transmission of forces.

Another important advantage is that the rocking system of the central arm enables alignment errors between the crane and the vertical or near-vertical concrete surface, or between tower anchors (or concrete surface) and the crane climbing frames to be absorbed to a certain extent. The tilting of the spherical supports together with the tilting of the central support arm of the “spikes” provides support even when they are off-centre and facilitates the self-correction of any possible coupling position and alignment errors.

It should also be highlighted that, in addition to this capacity to absorb errors of interlockings to the vertical and near-vertical concrete surface, the very design of the spikes also favours their entry and centring in vertical and near-vertical concrete surfaces. To this end, they have a series of lead chamfers to guide their entry and, following this effect, the free rotations of the spherical support on the central shaft and of the central arm facilitate entry and correct support of the spikes in the metal inserts.

Another advantage of this invention is that since there is a spherical support on the interlockings that can absorb manufacturing and alignment errors and transfer the support loads in the central zone of the segment of the vertical and near-vertical concrete surface, load transmission to the segment is mainly compression which is that best withstood by concrete.

Another of the most important advantages to be highlighted is that the support on the vertical and near-vertical concrete surface is by simply adding metal inserts that are welded, secured with wire or another means to the internal reinforcement of the segment, so that lateral loads are transferred to the concrete through the concrete reinforcement, and they are, in their simplest solution, turned parts that can be fixed to the mould when the segment is concreted during its manufacturing process, with practically no variation or increase in cost.

Another additional advantage is that, in the alternative embodiment in a buttonhole shape, greater alignment errors are able to be absorbed, so that there are greater entry tolerances at the top part of these, this way providing an even better guarantee that the interlocking spikes enter the tower and then, upon descending, support and centre in the same way as if they were totally round in shape.

It must also be highlighted that the invention presented here can be applied to any self-climbing structure that supports any device or machine, such as, for example, a crane or a work platform, and that it is applicable and usable both on flat or curved, vertical and near-vertical surfaces with a free form and variable incline, with progressions or individual movements of variable length, adapted to the structure or zone to be climbed.

### DESCRIPTION OF THE FIGURES

To gain a better understanding of the object of this invention, a preferred practical embodiment of an anchor for self-climbing structure is shown in the drawing attached. In the said drawing, FIG. 1—shows a general view of a vertical or near-vertical concrete surface, consisting, in this example, of a modular precast concrete tower with a self-climbing structure supporting a crane, showing amplified details of the top coupling, self-motorised and movable along the self-climbing structure, of the more or less intermediate coupling of the self-climbing structure, and of some metal inserts in one of the segments of the precast concrete tower.

FIG. 2—shows an amplified detail of the central part of the self-climbing structure, in which one of the frames can be seen with its interlocking spikes withdrawn and another frame, positioned under the previous frame, with its interlocking spikes inserted in the metal inserts.

FIG. 3—shows a detail of the interlocking spikes entering the metal inserts, seen from inside the tower, in the embodiment with through-hole openings in the wall.

FIG. 4—shows a front view of a set of interlocking spikes, central arm and main support of the assembly.

FIG. 5—shows a front view of a set of interlocking spikes, central arm and main support of the assembly, with one of the interlocking spikes and part of the central arm in a cut-away view to show their interior elements.

FIG. 6—shows a front view of a set of interlocking spikes, central arm and main support of the assembly, with the central arm, main support and shaft in a cut-away view to show their interior elements.

FIG. 7a—shows a perspective view of a metal insert, and FIG. 7b—shows that perspective view of the metal insert in a cut-away view, in both cases, in the embodiment with through-hole openings in the wall.

FIG. 8a—shows a perspective view of an interlocking spike facing a metal insert, FIG. 8b—shows these same elements in a vertical cut-away view, and FIG. 8c—shows them in a horizontal cut-away view.

FIGS. 9a, 9b, 9c, 9d and 9e—show simplified views of two interlocking spikes on the central arm and two metal inserts, with the axes of rotation of both the interlocking spikes and the central arm, showing how they can offset various horizontal and vertical misalignments, both in the insertion of the interlocking spikes and in the location of the metal inserts.

FIG. 10a—shows round metal inserts, while FIG. 10b—shows metal inserts with a buttonhole shape.

### PREFERRED EMBODIMENT OF THE INVENTION

The conformation and characteristics of the invention can be better understood in the following description that relates to the attached figures.

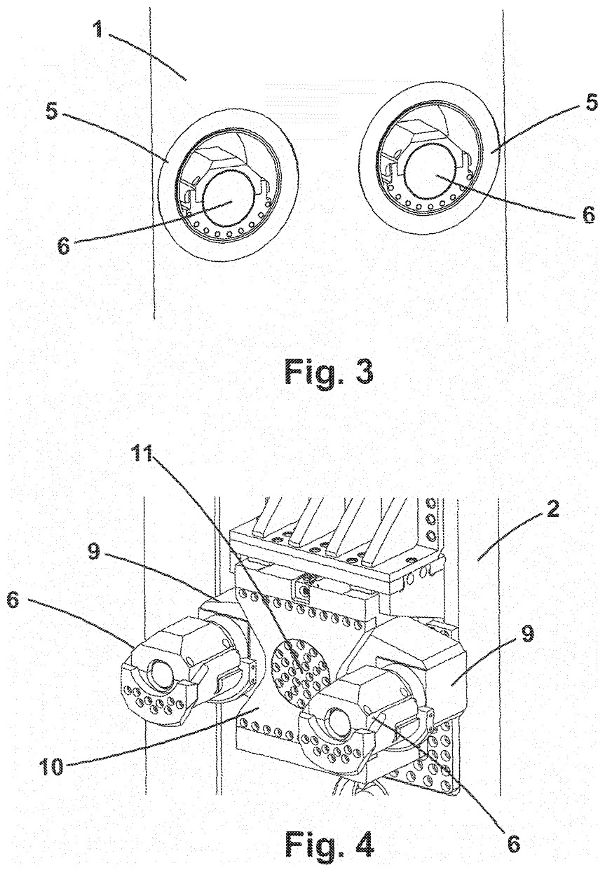

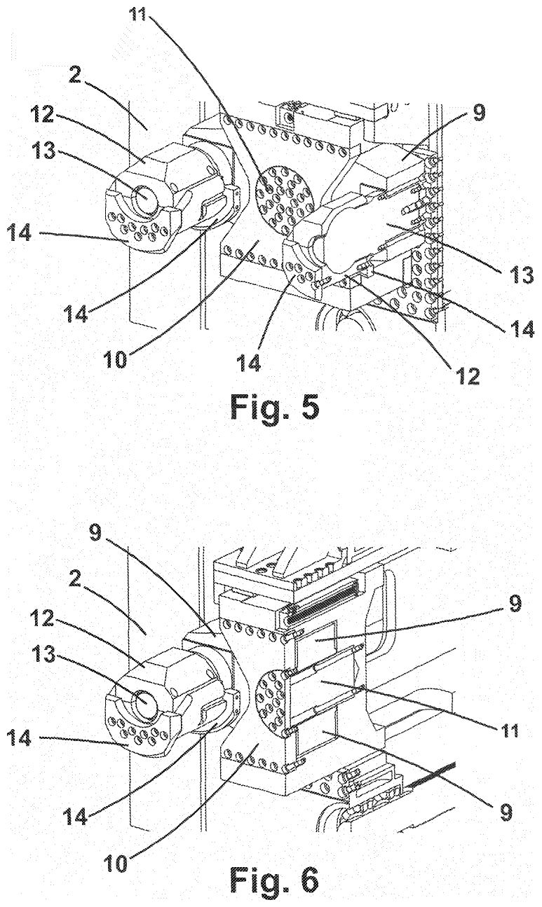

As can be seen in FIG. 1, an anchor for a self-climbing structure (2) is illustrated, of the type used on vertical and near-vertical concrete surfaces, for example in the assembly and maintenance of precast concrete towers (1), the self-climbing structure (2) being able to be used for the support of cranes (3), platforms, and other auxiliary elements. As illustrated in FIGS. 1, 2, 3, 4, 5 and 6 it comprises
on the vertical or near-vertical concrete surface (1), a plurality of metal inserts (5) fixed to the internal reinforcement of the segment, which form openings in the wall of the said segment, distributed at different heights on the vertical or near-vertical concrete surface (1),
in the self-climbing structure (2), interlocking spikes (6), with a distribution and dimensions suitable for insertion and coupling in the metal inserts (5), located in frames (4a, 4b and 4c) of said self-climbing structure (2), the interlocking spikes (6) being provided with means of horizontal and vertical displacement (7) and with means of approach and distancing (8) in relation to the vertical or near-vertical concrete surface (1).

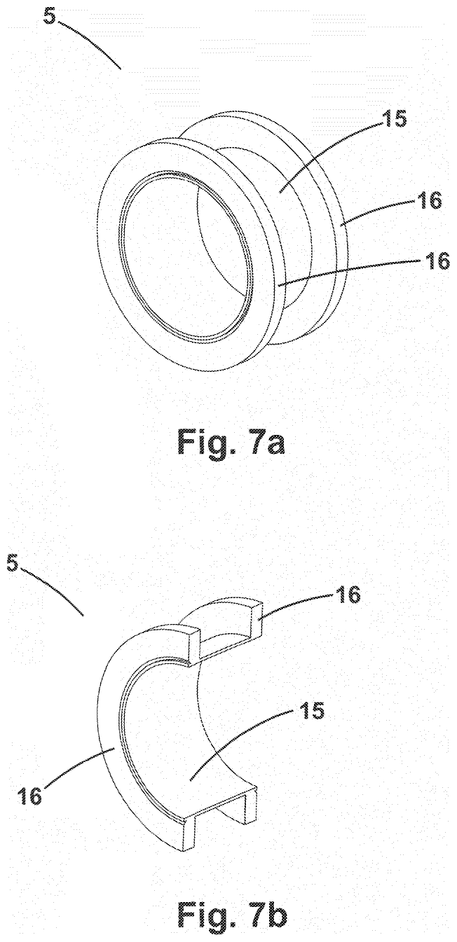

The openings in the wall can be through-hole openings, and in this case the metal inserts (5), as shown in FIGS. 7a and 7b are shaped as a hollow body (15) finished at both its ends by two peripheral end surfaces (16) of a larger size, defining a common through-hole opening.

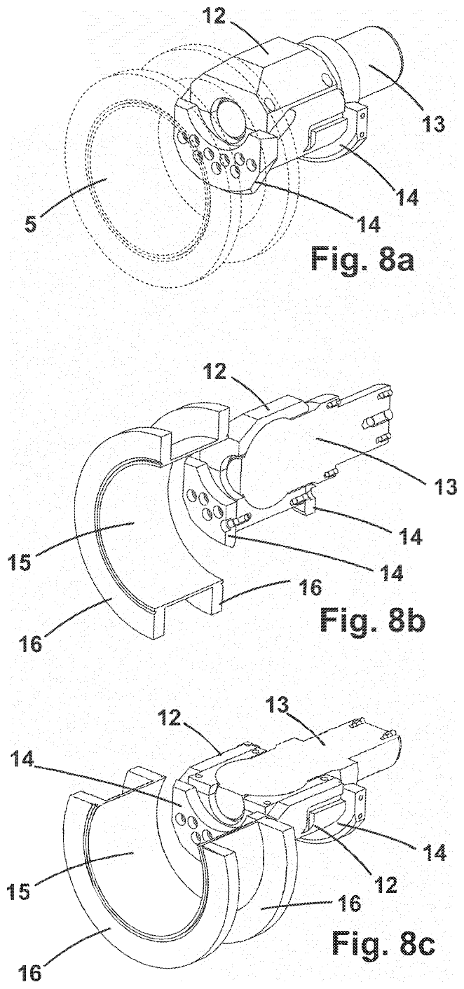

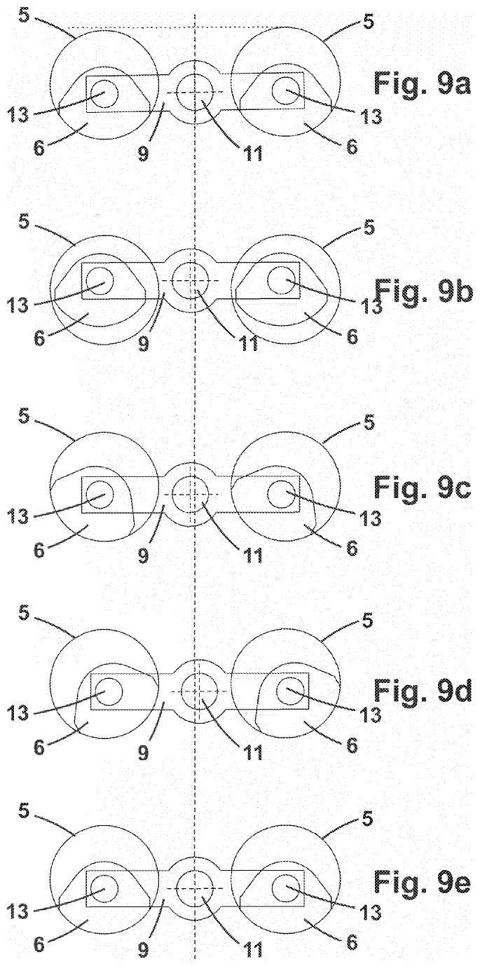

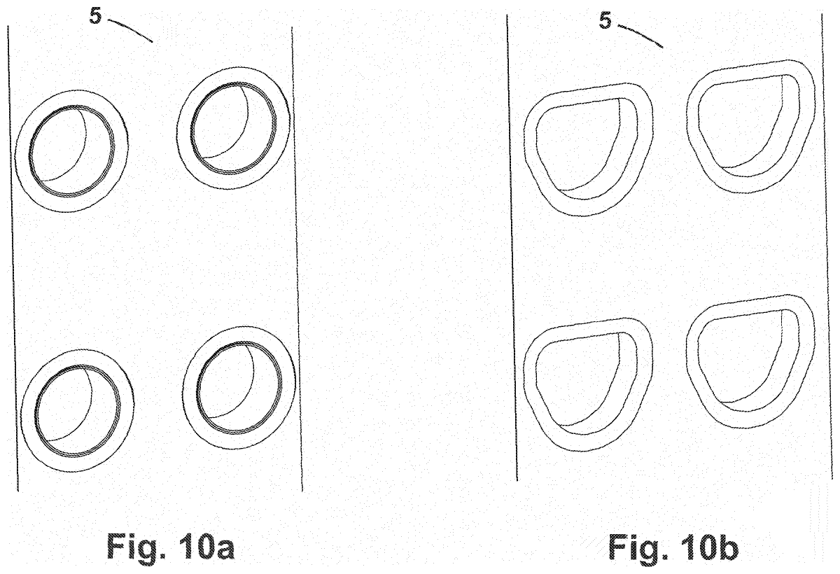

An alternative embodiment is envisaged in which the wall openings are not through-holes and adopt the form of a hollow or niche. In both cases they can adopt a circular shape, as shown in FIG. 10a or alternatively as shown in FIG. 10b, a buttonhole shape, in which the top part is wider than the lower part, the lower part being semi-circular in shape. The interlocking spikes (6) comprise, as is shown in FIGS. 8a, 8b and 8c,
an inner shaft (13), provided with a spherical end,
a main body (12), enveloping the spherical end of the inner shaft (13), and provided with free rotation movement in relation to it, the lower part of the main body (12) being semi-circular,
end plates (14) attached to the front and rear ends of the main body (12), and which protrude from the said main body (12) at the bottom,

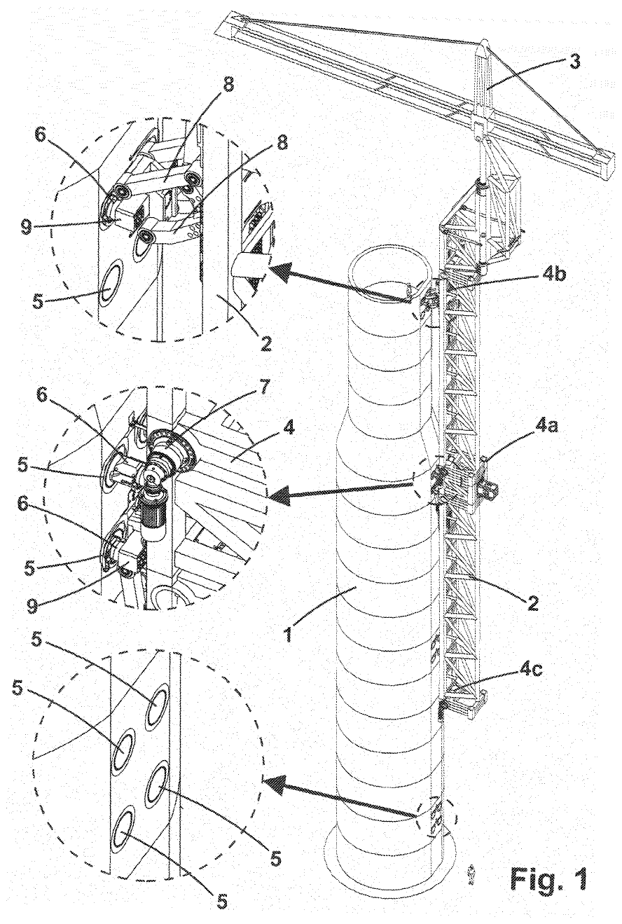

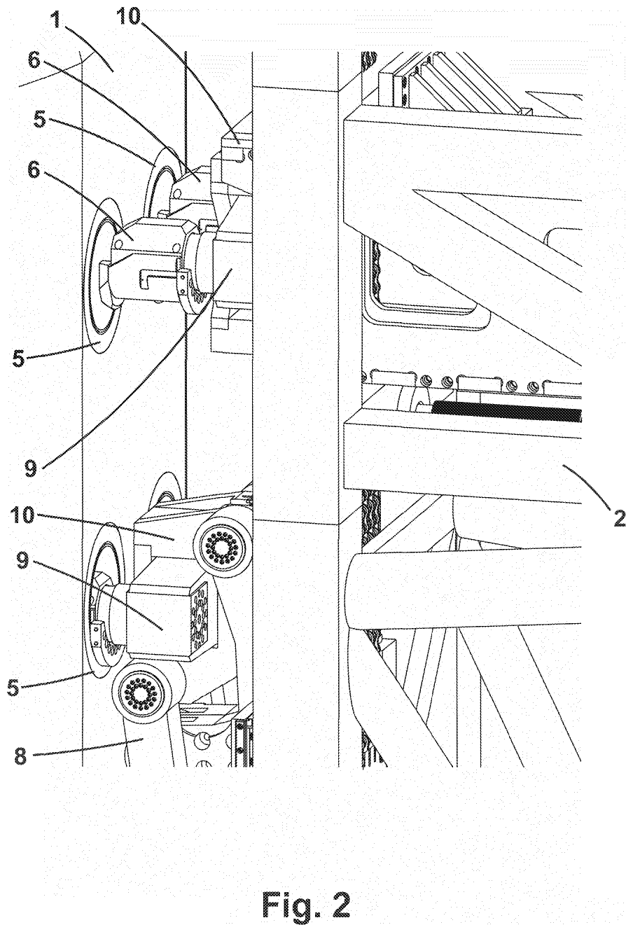

In a coupling position as illustrated in FIG. 2, the interlocking spikes (6) are inserted in some of the metal inserts (5), in such a way that the lower part of each main body (12) of the interlocking spike (6) is in contact with the inner part of the hollow body (15) of its corresponding metal insert (5), while the end plates (14) remain fitted against the peripheral end surfaces (16) of the metal inserts (5).

In a preferred embodiment, the interlocking spikes (6) are distributed in pairs, at the same height, on each frame (4a, 4b and 4c), the metal inserts (5) being distributed vertically aligned in groups of two at the same height, at each height established for coupling on the vertical or near-vertical concrete surface (1). In an alternative embodiment, the interlocking spikes (6) are distributed as one per frame (4a, 4b and 4c), the metal inserts (5) being distributed vertically aligned, as one at each height established for coupling on the vertical or near-vertical concrete surface (1). It is technically possible to carry out other variants with groups of three or more interlocking spikes (6) on each frame and, correspondingly, with groups of three or more metal inserts (5) at each height.

In a preferred embodiment two of the frames (4b and 4c) are self-motorised and movable along the self-climbing structure (2) and at least one of them is a frame (4a) fixed to the self-climbing structure (2). An alternative embodiment is also envisaged in which all of the frames (4a, 4b and 4c) are self-motorised and movable along the self-climbing structure (2).

The interlocking spikes (6), if grouped in pairs, are fixed by pairs, as shown in FIGS. 4,5 and 6, by means of the rear end of the inner shaft (13) on both ends of a central arm (9), provided with free rotation movement by means of a shaft (11), with respect to the main support (10) of the assembly. Preferably the interlocking spikes (6) are provided with multiple chamfers both on the main body (12) and on the end plates (14).

A person skilled in the art will easily comprehend that the characteristics of different embodiments can be combined with the characteristics of other possible embodiments, provided that the combination is technically possible. All of the information referring to examples or embodiments form part of the description of the invention.

1. An Anchor for self-climbing structure on a vertical or near-vertical concrete surface characterised in that it comprises
on the vertical or near-vertical concrete surface (1), a plurality of metal inserts (5) fixed to the internal reinforcement of the segment, which form openings in the wall of the said segment, distributed at different heights on the vertical or near-vertical concrete surface (1),
in the self-climbing structure (2), interlocking spikes (6), with a distribution and dimensions suitable for insertion and coupling in the metal inserts (5), located in frames (4a, 4b and 4c) of the said self-climbing structure (2), the interlocking spikes (6) being provided with means of horizontal and vertical displacement (7) and with means of approach and distancing (8) in relation to the vertical or near-vertical concrete surface (1),
and the interlocking spikes (6) comprising
an inner shaft (13), provided with a spherical end,
a main body (12), enveloping the spherical end of the inner shaft (13), and provided with free rotation movement in relation to it, the lower part of the main body (12) being semi-circular, and
end plates (14) attached to the front and rear ends of the main body (12), and which protrude from the said main body (12) at the bottom.

2. The anchor for self-climbing structure, according to claim 1, wherein the metal inserts (5) are shaped as a hollow body (15) finished at both ends by two peripheral end surfaces (16) of a larger size, defining a common through-hole opening.

3. The anchor for self-climbing structure, according to claim 1 wherein the openings in the wall formed by the metal inserts (5) are through-hole openings.

4. The anchor for self-climbing structure, according to claim 1, wherein the openings in the wall formed by the metal inserts (5) are not through-hole openings, and form a hollow or niche.

5. The anchor for self-climbing structure, according to claim 1, wherein the interlocking spikes (6) are distributed one per each frame (4a, 4b y 4c), the metal inserts (5) being distributed vertically aligned, one at each height established for coupling on the vertical or near-vertical concrete surface (1).

6. The anchor for self-climbing structure, according to claim 1, wherein the interlocking spikes (6) are distributed in pairs, at the same height, on each frame (4a, 4b and 4c), the metal inserts (5) being distributed vertically aligned in groups of two at the same height, at each height established for coupling on the vertical or near-vertical concrete surface (1).

7. The anchor for self-climbing structure, according to claim 1, wherein the interlocking spikes (6) are fixed by pairs, by means of the rear end of the inner shaft (13), on both ends of a central arm (9), provided with free rotation movement by means of a shaft (11) with respect to the main support (10) of the assembly.

8. The anchor for self-climbing structure, according to claim 1, wherein the frames (4a, 4b and 4c) are self-motorised and movable along the self-climbing structure (2).

9. The anchor for self-climbing structure, according to claim 1, wherein two of the frames (4b and 4c) are self-motorised and movable along the self-climbing structure (2), and at least one of them is a frame (4a) fixed to the self-climbing structure (2).

10. The anchor for self-climbing structure, according to claim 1, wherein the interlocking spikes (6) are provided with multiple chamfers, both on the main body (12) and on the end plates (14).

11. The anchor for self-climbing structure, according to claim 1, wherein the metal inserts (5) adopt a shape chosen from the group formed by a circular shape and a buttonhole shape, in which the top part is wider than the bottom part, the bottom part being semi-circular in shape.

12. The anchor for self-climbing structure, according to claim 1, wherein in a coupling position, the interlocking spikes (6) are inserted in some of the metal inserts (5), in such a way that the lower part of each main body (12) of the interlocking spike (6) is in contact with the inner part of the hollow body (15) of its corresponding metal insert (5), while the end plates (14) remain fitted against the peripheral end surfaces (16) of the metal inserts (5).
